(19) United States
(12) Patent Application Publication
(10) Pub. No.: US 2012/0117360 A1
(43) Pub. Date: May 10, 2012

(54) DEDICATED INSTRUCTIONS FOR VARIABLE LENGTH CODE INSERTION BY A DIGITAL SIGNAL PROCESSOR (DSP)

(75) Inventor: Jagadeesh SANKARAN, Allen, TX (US)

(73) Assignee: TEXAS INSTRUMENTS INCORPORATED, Dallas, TX (US)

(21) Appl. No.: 12/942,544

(22) Filed: Nov. 9, 2010

(51) Int. Cl. G06F 9/30; G06F 9/315

(52) U.S. Cl. 712/226; 712/E09.016; 712/E09.034

(57) ABSTRACT

In accordance with at least some embodiments, a digital signal processor (DSP) includes an instruction fetch unit and an instruction decode unit in communication with the instruction fetch unit. The DSP also includes a register set and a plurality of work units in communication with the instruction decode unit. The DSP selectively uses a dedicated insert instruction to insert a variable number of bits into a register.

### BACKGROUND

One of the fundamental operations in video encoding or multi-channel transrating is to use variable length codes (e.g., Huffman codes) to model different values for syntax elements. For example, compression of audio, video and/or speech may rely on such variable length codes. For Huffman coding, the symbols are ordered according to probability of use with the most often occurring values of syntax elements being assigned shorter length codes. Improving the speed of variable length code insertion (reducing the number of processing cycles needed for the operation) improves the overall speed of operations such as video encoding and video transrating.

### SUMMARY

In accordance with at least some embodiments, a digital signal processor (DSP) includes an instruction fetch unit and an instruction decode unit in communication with the instruction fetch unit. The DSP also includes a register set and a plurality of work units in communication with the instruction decode unit. The DSP selectively uses a dedicated insert instruction to insert a variable number of bits into a register.

In at least some embodiments, a system includes a data source that provides workload data and a DSP coupled to the data source. The DSP modifies the workload data from the data source using a dedicated insert instruction that inserts a variable number of bits into the workload data. The system further comprises a data sink that receives the modified workload data from the DSP.

In at least some embodiments, a method includes receiving, by a DSP, workload data and inserting, by the DSP, a variable number of bits into the workload data using a dedicated insert instruction. The method also includes tracking, by the DSP, a bit pointer location adjacent inserted bits using a dedicated bit pointer tracking instruction associated with the dedicated insert instruction.

### BRIEF DESCRIPTION OF THE DRAWINGS

For a detailed description of exemplary embodiments of the invention, reference will now be made to the accompanying drawings in which:

FIG. 1 illustrates a mobile computing system in accordance with an embodiment of the disclosure;

FIG. 2 illustrates a digital signal processor (DSP) core architecture in accordance with an embodiment of the disclosure;

FIG. 3 illustrates a system in accordance with an embodiment of the disclosure;

FIGS. 4A-4C illustrate a variable length code insertion process in accordance with an embodiment of the disclosure; and

FIG. 5 illustrates a method in accordance with an embodiment of the disclosure.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

One of the fundamental operations in video encoding or multi-channel transrating is to use variable length codes to model different syntax elements. This is how audio or video is compressed. For example, Huffman coding varies the length of multi-bit codes corresponding to information based on probability of use (i.e., more probable values are assigned shorter codes).

Embodiments of the disclosure are directed to techniques for improving the speed of variable length code insertion and thereby improve the speed of operations (e.g., video encoding and/or multi-channel transrating) that rely on variable length code insertion. In at least some embodiments, a dedicated insert instruction is employed by a digital signal processor (DSP) architecture to perform variable length code insertion. Further, a dedicated bit pointer maintenance instruction is employed by the DSP in conjunction with the dedicated insert instruction to track a bit pointer location resulting from variable length code insertion. The techniques described herein may be implemented, for example, with a very-long instruction word (VLIW) architecture such as the C64x™ or C64x+™ DSP architectures.

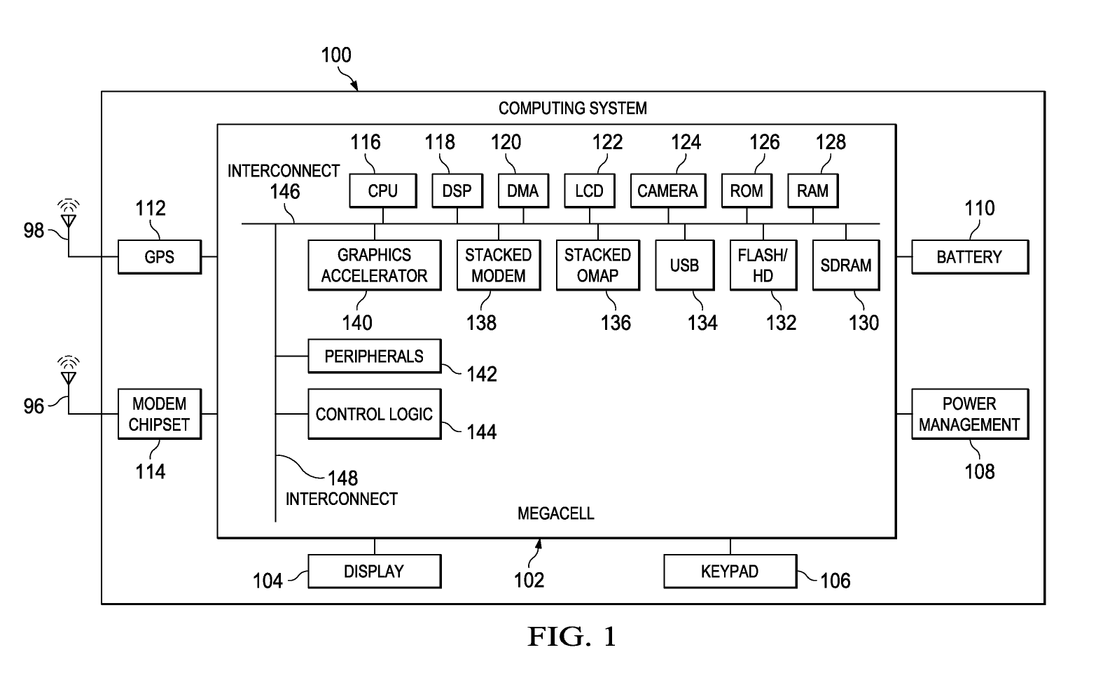

FIG. 1 shows a mobile computing system 100 in accordance with at least some embodiments of the invention. In accordance with embodiments, the mobile computing system 100 employs a dedicated insert instruction and a dedicated bit pointer maintenance instruction with digital signal processor (DSP) 118 as described herein. Although mobile computing system 100 is representative of an Open Multimedia Application Platform (OMAP) architecture, the scope of disclosure is not limited to any specific architecture.

As shown, the mobile computing system 100 contains a megacell 102 which comprises a processor core 116 (e.g., an ARM core) and DSP 118 which aids the core 116 by performing task-specific computations, such as graphics manipulation and speech processing. The megacell 102 also comprises a direct memory access (DMA) 120 which facilitates direct access to memory in the megacell 102. The megacell 102 further comprises liquid crystal display (LCD) logic 122, camera logic 124, read-only memory (ROM) 126, random-access memory (RAM) 128, synchronous dynamic RAM (SDRAM) 130 and storage (e.g., flash memory or hard drive) 132. The megacell 102 may further comprise universal serial bus (USB) logic 134 which enables the system 100 to couple to and communicate with external devices. The megacell 102 also comprises stacked OMAP logic 136, stacked modem logic 138, and a graphics accelerator 140 all coupled to each other via an interconnect 146. The graphics accelerator 140 performs necessary computations and translations of information to allow display of information, such as on display 104. Interconnect 146 couples to interconnect 148, which couples to peripherals 142 (e.g., timers, universal asynchronous receiver transmitters (UARTs)) and to control logic 144.

As an example, the mobile computing system 100 may correspond to devices such as a cellular telephone, a personal digital assistant (PDA), a text messaging system, and/or a smart phone. Thus, some embodiments may comprise a modem chipset 114 coupled to an antenna 96 and/or global positioning system (GPS) logic 112 likewise coupled to an antenna 98.

The megacell 102 further couples to a battery 110 which provides power to the various processing elements. The battery 110 may be under the control of a power management unit 108. In some embodiments, a user may input data and/or messages into the mobile computing system 100 by way of the keypad 106. Because many mobile devices have the capability of taking digital still and video pictures, in some embodiments, the computer system 100 may comprise a camera interface 124 which enables camera functionality. For example, the camera interface 124 may enable selective charging of a charge couple device (CCD) array (not shown) for capturing digital images.

Although the discussion of FIG. 1 is provided in the context of a mobile computing system 100, the employment of a dedicated bit insert instruction and a bit pointer tracking instruction with a DSP is not limited to mobile computing environments. Further, in accordance with at least some embodiments of the invention, many of the components illustrated in FIG. 1, while possibly available as individual integrated circuits, preferably are integrated or constructed onto a single semiconductor die. As an example, the core 116, the DSP 118, DMA 120, camera interface 124, ROM 126, RAM 128, SDRAM 130, storage 132, USB logic 134, stacked OMAP 136, stacked modem 138, graphics accelerator 140, control logic 144, along with some or all of the remaining components, preferably are integrated onto a single die, and thus may be integrated into the mobile computing device 100 as a single packaged component. Having multiple devices integrated onto a single die, especially devices comprising core 116 and RAM 128, may be referred to as a system-on-chip (SoC) or a megacell 102. While using a SoC is preferred in some embodiments, obtaining benefits of a dedicated insert instruction and a dedicated bit pointer maintenance instruction within DSP opcode does not require the use of a SoC.

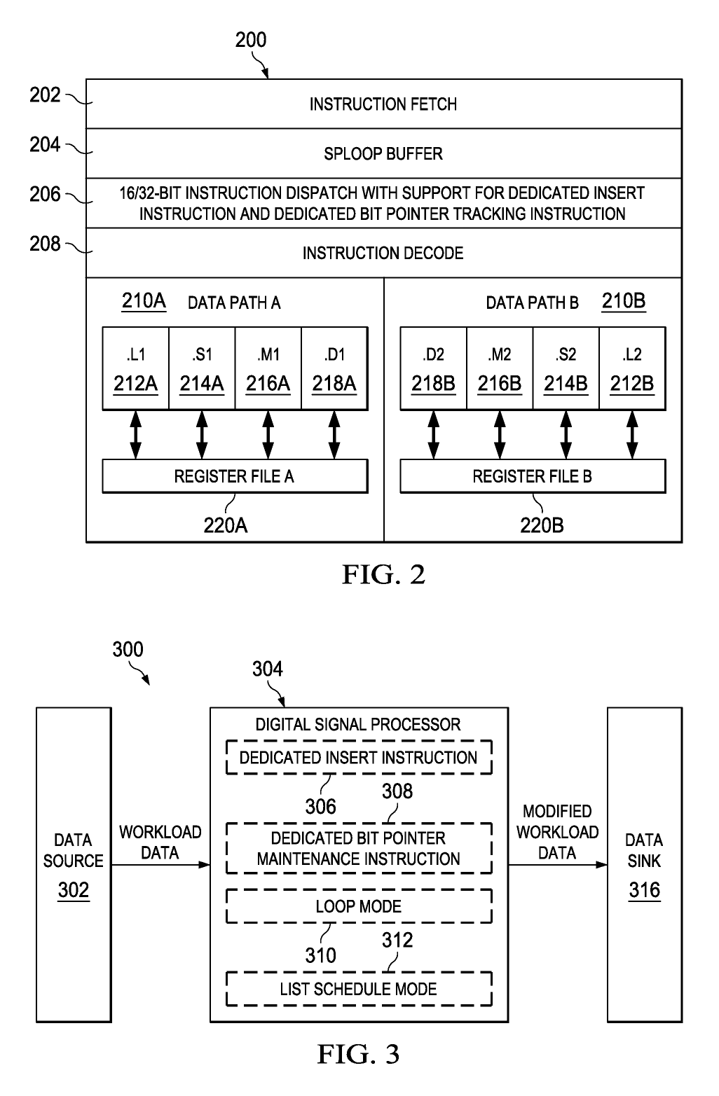

FIG. 2 illustrates a digital signal processor (DSP) core architecture 200 in accordance with an embodiment of the disclosure. The DSP architecture 200 corresponds to the C64x+™ DSP core, but may also correspond to other DSP cores as well. In general, the C64x+™ DSP core is an example of a very-long instruction word (VLIW) architecture. As shown in FIG. 2, the DSP core architecture 200 comprises an instruction fetch unit 202, a software pipeline loop (SPLOOP) buffer 204, a 16/32-bit instruction dispatch unit 206, and an instruction decode unit 208. The instruction fetch unit 202 is configured to manage instruction fetches from a memory (not shown) that stores instructions/data for use by the DSP core architecture 200. The SPLOOP buffer 204 is configured to store a single iteration of a loop and to selectively overlay copies of the single iteration in a software pipeline manner. The 16/32-bit instruction dispatch unit 206 is configured to split the fetched instruction packets into execute packets, which may be one instruction or multiple parallel instructions (e.g., two to eight instructions). The 16/32-bit instruction dispatch unit 206 also assigns the instructions to the appropriate work units described herein. In accordance with at least some embodiments, the 16/32-bit instruction dispatch unit 206 is configured to support a dedicated insert instruction and a dedicated bit pointer maintenance instruction. The instruction decode unit 208 is configured to decode the source registers, the destination registers, and the associated paths for the execution of the instructions in the work units described herein.

In accordance with C64x+ DSP core embodiments, the instruction fetch unit 202, 16/32-bit instruction dispatch unit 206, and the instruction decode unit 208 can deliver up to eight 32-bit instructions to the work units every CPU clock cycle. The processing of instructions occurs in each of two data paths 210A and 210B. As shown, the data path A 210A comprises work units, including a L1 unit 212A, a S1 unit 214A, a M1 unit 216A, and a D1 unit 218A, whose outputs are provided to register file A 220A. Similarly, the data path B 210B comprises work units, including a L2 unit 212B, a S2 unit 214B, a M2 unit 216B, and a D2 unit 218B, whose outputs are provided to register file B 220B.

In accordance with C64x+ DSP core embodiments, the L1 unit 212A and L2 unit 212B are configured to perform various operations including 32/40-bit arithmetic operations, compare operations, 32-bit logical operations, leftmost 1 or 0 counting for 32 bits, normalization count for 32 and 40 bits, byte shifts, data packing/unpacking, 5-bit constant generation, dual 16-bit arithmetic operations, quad 8-bit arithmetic operations, dual 16-bit minimum/maximum operations, and quad 8-bit minimum/maximum operations. The S1 unit 214A and S2 unit 214B are configured to perform various operations including 32-bit arithmetic operations, 32/40-bit shifts, 32-bit bit-field operations, 32-bit logical operations, branches, constant generation, register transfers to/from a control register file (the S2 unit 214B only), byte shifts, data packing/unpacking, dual 16-bit compare operations, quad 8-bit compare operations, dual 16-bit shift operations, dual 16-bit saturated arithmetic operations, and quad 8-bit saturated arithmetic operations. The M1 unit 216A and M2 unit 216B are configured to perform various operations including 32×32-bit multiply operations, 16×16-bit multiply operations, 16×32-bit multiply operations, quad 8×8-bit multiply operations, dual 16×16-bit multiply operations, dual 16×16-bit multiply with add/subtract operations, quad 8×8-bit multiply with add operation, bit expansion, bit interleaving/de-interleaving, variable shift operations, rotations, and Galois field multiply operations. The D1 unit 218A and D2 unit 218B are configured to perform various operations including 32-bit additions, subtractions, linear and circular address calculations, loads and stores with 5-bit constant offset, loads and stores with 15-bit constant offset (the D2 unit 218B only), load and store doublewords with 5-bit constant, load and store nonaligned words and doublewords, 5-bit constant generation, and 32-bit logical operations. Each of the work units reads directly from and writes directly to the register file within its own data path. Each of the work units is also coupled to the opposite-side register file's work units via cross paths. For more information regarding the architecture of the C64x+ DSP core and supported operations thereof, reference may be had to Literature Number: SPRU732H, “TMS320C64x/C64x+ DSP CPU and Instruction Set”, October 2008, which is hereby incorporated by reference herein.

Variable length code insertion can be performed by the C64x and C64x+ DSP architectures without the dedicated insert instruction and the dedicated bit pointer instruction described herein, but the performance is reduced. When performing variable length code insertion, a worklist may be built instead of performing variable length code insertion one code at a time. The worklist enables use of software pipelining to achieve an additional boost in performance. The serial assembly code for a legacy variable length code insertion technique is shown below.

| | .global_vlc | | | | |
|---|---|---|---|---|---|
| - vlc: | .cproc A_len_ptr, B_code_ptr, A_out_ptr, B_struct, A_n | | | | |
| | .reg A_32, B_struct_c, | | | A_struct | |
| | .reg B_bp, B_outw | | | | |
| | .reg A_code, B_len | | | | |
| | .reg A_nbp, B_csh, | | A_csl | | |
| | .reg B_bp_, A_f, | | | B_32 | |
| | MV B_struct, | | | B_struct_c | |
| | MV B_struct, | | | A_struct | |
| | LDW *B_struct++[2], | | | B_bp | |
| | LDW *A_struct++[2], | | | A_out_ptr | |
| | LDW *B_struct++[2], | | | B_outw | |
| | MVK 32, | | A_32 | | |
| | MVK 32, | | B_32 | | |
| LOOP: | | | | | |
| | LDW *B_code_len_ptr++, A_code: A_len | | | | |
| | SUB | A_32, | B_bp, | A_nbp | |
| | SHRU | A_code, | B_bp, | B_csh | |
| | SHL | A_code, | A_nbp, | | A_csl |
| | ADD | B_bp, | A_len, | | B_bp_ |
| | AND | B_bp_, | A_32, | A_f | |
| | ANDN | B_bp_, | B_32, | B_bp | |
| | OR | B_csh, | B_outw, | | B_outw |
| | [A_f] STW | B_outw, | | *A_out_ptr++ | |
| | [A_f] MV A_csl, | | B_outw | | |
| | [A_n] SUB | A_n, | 1, | A_n | |

[A_n] B LOOP

| MV B_struct_c, | B_struct |
|---|---|
| MV B_struct, | A_struct |
| STW B_bp, | *B_struct++[2] |
| STW A_out_ptr, | *A_struct++[2] |
| STW B_outw, | *B_struct++[2] |
| .return | |
| .endproc | |

The above serial assembly code, when run through the software pipeliner, produces the 3 cycle loop shown here:

| | |
|---|---|
| $C$L1: | ; PIPED LOOP PROLOG |

| | [A_n] BDEC | .S2 | $C$L2,A_n | ; \|43\| (P) <0,3> |
|---|---|---|---|---|
| ∥ | LDDW | .D2T2 | *B_code_ptr′++, A_code′A_len ; \|25\| (P) <1,0> | |
| | MV | .L1X | B_struct″, B_struct_c ; \|2\| | |
| ∥ | MVK | .S1 | 0x20,A_32 | ; \|17\| |
| ∥ | MVK | .S2 | 0x20,B_32 | ; \|18\| |
| | MV | .L1X | A_code′, A_code | ; \|25\| (P) <0,5> Define a twin register |

| | | | |
|---|---|---|---|
| ∥ | ADD | .L2 | B_bp,A_len,B_bp_ ; \|32\| (P) <0,5> \hat{ } |
| ∥ | SHRU | .S2 | A_code′,B_bp,B_csh ; \|29\| (P) <0,5> |

| ;**------------------------------------------------------------------------------------* | |
|---|---|
| $C$L2: | ; PIPED LOOP KERNEL |

| $C$DW$L$_vlc$3$B: | | | | |
|---|---|---|---|---|
| | ANDN | .L2 | B_bp_,B_32,B_bp | ; \|35\| <0,6> \hat{ } |
| ∥ | SUB | .L1X | A_32,B_bp,A_nbp | ; \|27\| <0,6> \hat{ } |
| ∥ | [A_n] BDEC | .S2 | $C$L2,A_n | ; \|43\| <1,3> |

| | | | |
|---|---|---|---|
| ∥ | LDDW | .D2T2 | *B_code_ptr′++,A_code′:A_len ; \|25\| <2,0> |
| | AND | .L2X | B_bp_,A_32,A_f ; \|34\| <0,7> |
| ∥ | SHL | .S1 | A_code,A_nbp,A_csl ; \|30\| <0,7> |
| ∥ | OR | .L1X | B_csh,B_outw,B_outw ; \|37\| <0,7> \hat{ } |
| | [A_f] MV | .S1 | A_csl,B_outw ; \|40\| <0,8>\hat{ } |
| ∥ | [A_f] STW | .D1T1 | B_outw,*A_out_ptr++; \|39\| <0,8> \hat{ } |
| ∥ | MV | .L1X | A_code′,A_code ; \|25\| <1,5> Define a twin register |
| ∥ | ADD | .L2 | B_bp,A_len,B_bp_ ; \|32\| <1,5> \hat{ } |
| ∥ | SHRU | .S2 | A_code′,B_bp,B_csh ; \|29\| <1,5> |

The same serial assembly code when compiled for the C64x+ architecture uses the SPLOOP mechanism and achieves a 2 cycle loop thereby showing a 33% improvement relative to the C64x architecture. Code for the C64x+ architecture is shown below after making a slight change to the serial assembly code, where instead of using LDDW to load code and length as a single double word, two load words are used to load the words on opposite data paths.

| LOOP: | | | | |
|---|---|---|---|---|
| LDW | *B_code_ptr++, A_code | | | |
| LDW | *A_len_ptr++, B_len | | | |
| SUB | A_32, | B_bp, | | A_nbp |
| SHRU | A_code, | B_bp, | | B_csh |
| SHL | A_code, | A_nbp, | | A_csl |
| ADD | B_bp, | B_len, | | B_bp_ |
| AND | B_bp_, | A_32, | | A_f |
| ANDN | B_bp_, | B_32, | | B_bp |
| OR | B_csh, | B_outw, | | B_outw |
| [A_f] STW | B_outw, | *A_out_ptr++ | | |
| [A_f] MV | A_csl, | B_outw | | |
| [A_n] SUB | A_n, | 1, | A_n | |

| | |
|---|---|
| [A_n] B | LOOP |

The scheduled C64x+ code is shown below:

| $C$L1: ; PIPED LOOP PROLOG | | | |
|---|---|---|---|
| | SPLOOP 2 | ;10 | ;(P) |

| ;**-------------------------------------------------------------------------------------* | |
|---|---|
| $C$L2: | ; PIPED LOOP KERNEL |

| $C$DW$L$_vlc$3$B: | | | |
|---|---|---|---|
| | LDW | .D2T2 | *A_len_ptr++,B_len ; \|26\| (P) <0,0> |
| ∥ | LDW | .D1T1 | *B_code_ptr++,A_code ; \|25\| (P) <0,0> |
| | NOP | 4 | |
| | ROTL | .M1 | A_code,0,A_code′ ; \|25\| (P) <0,5> Split a long life |
| | ADD | .L2 | B_bp,B_len,B_bp_ ; \|33\| (P) <0,6> \hat{ } |
| ∥ | SHRU | .S2X | A_code,B_bp,B_csh ; \|30\| (P) <0,6> |
| | AND | .LX2 | B_bp_,A_32,A _f ; \|35\| (P) <0,7> |
| ∥ | ANDN | .S2 | B_bp_,B_32,B_bp ; \|36\| (P) <0,7> |
| ∥ | SUB | .L1X | A_32,B_bp,A_nbp ; \|28\| (P) <0,7> \hat{ } |
| | SHL | .S1 | A_code′,A_nbp,A_csl; \|31\| <0,8> |
| ∥ | OR | .L1X | B_csh,B_outw,B_outw ; \|38\| <0,8> \hat{ } |

SPKERNEL 4,0

| | | |
|---|---|---|
| ∥ [A_f] MV | .S1 | A_csl,B_outw ; \|41\| <0,9> \hat{ } |
| ∥ [A_f] STW | .D2T1 | B_outw,*A_out_ptr++; \|40\| <0,9> \hat{ } |

In a steady-sate in the loop buffer will appear as follows:

| LOOP: | | | |
|---|---|---|---|
| | OR | .D2 | B_csh, B_outw, B_outw ; [9,1] |
| ∥ | ANDN | .L2 B_bp_, B_32, B_bp ; [7,2] | |
| ∥ | SHRU | .S2X | A_code, B_bp, B_csh ; [7,2] |
| ∥ | SUB | .S1X | A_32, B_bp, A_nbp ; [7,2] |
| ∥ | LDW | .D1T2 | *A_lenptr++, B_len ; [1,5] |
| | [A_f]MV | .L2X | A_csl, B_outw ;[10,1] |
| ∥ | [A_f]STW | .D1T2 | B_outw, *A_out_ptr++ ;[10,1] |
| ∥ | AND | .L1X | B_bp_, A_32, A_f ; [8,2] |
| ∥ | SHL | .S1 | A_code, A_nbp, A_csl ;[8,2] |
| ∥ | ADD | .S2 | B_bp, B_len, B_bp_ ; [6,3] |
| ∥ | LDW | .D2T1 | *B_codeptr++, A_code ; [2,5] |

In the above steady-state code all of the work units except M1 and M2 are used. In accordance with embodiments of the disclosure, use of the dedicated insert instruction and a dedicated pit pointer instruction for variable length code insertion doubles the performance of the looping case and reduces the number of cycles for the list-schedule case (the non-looping case) by 4. The improvement in performance is accomplished without modifying the load-store bandwidth.

With the dedicated insert instruction and dedicated bit pointer maintenance instruction disclosed herein, the performance of variable length code insertion is improved compared to the variable length code insertion techniques described previously (i.e., the number of cycles and/or the total number of work units needed to perform variable length code insertion is reduced). The dedicated insert (“INS”) instruction can be viewed as a generalization of the shift right merge byte, to any bit location as seen below.

### Dedicated Insert Instruction:

INS B_outw: B_code, B_bp, B_outw:B_code

The INS instruction results in the operations:

| | | | |
|---|---|---|---|
| SUB | A_32, B_bp, | A_nbp ; | nbp= 32 - bp |
| SHRU | A_code, | B_bp, B_csh | ; csh = code >> bp |
| SHL | A_code, | A_nbp, | A-csl ; csl = code << nbp |
| OR | B_csh, | B_outw, | B_outw ; outw \|= csh |

In at least some embodiments, the INS instruction operates within existing opcode limitations of the C64x, where only one double word source is specified. In order to facilitate use of the INS instruction, the output codeword (outw) is assumed to be a 32-bit field, which contains the partial word left justified. Meanwhile, the bit pointer (bp) which contains the number of bits from the left that have been filled has a value 0<=bp<=31. It is also assumed that the loaded codeword is maintained in memory left-justified. This method of maintaining bits is preferable as the partial word can be updated in a simple fashion as follows:

outw=(outw|(code>>bp))

The codeword may have some overflow bits that can be computed and placed in a next codeword as:

code=(code<<(32−bp))

With “outw” and “code” maintained in this way, variable length code insertion is possible without knowledge of “len”. Advantageously this technique is possible within the existing op-codes that are allowed in the C64x architecture. If, on the other hand, both the partial output codewords “outw” and “code” are maintained right-justified, then the following update operations will be needed.

shift=(len<(32−bp))?len:(32−bp);

outw=(outw<<shift)|(code>>(len−shift)); code=(code & (1<<(len−shift)−1))

As an example: if bp=30 and len=5 for the code, this will cause overflow since only 2 bits out of the 5 bits to be inserted can be accepted.

shift=(5<2)?5:2 results in shift=2.

outw=(outw<<2)|(code>>3), code=code & ((1<<3)−1)=code & 7;

(retain lower 3 bits)
As another example: if bp=28 and len=2 for the code, this will not cause overflow:

shift=(2<<4)?2:4 results in shift=4

outw=(outw<<2)|(code>>0); code=(code & ((1<<0)−1))=code &0=0

With the update equations, a compare and three shifts are needed and thus maintaining partial output codewords right-justified requires more operations than maintaining partial output codewords left-justified. Additionally, maintaining partial output codewords right-justified requires knowledge of both the bit pointer “bp” and the length of the inserted code “len”.

If the partial output word “outw” is maintained left-justified, then:

shift=(len<(32−bp))?len:(32−bp);

outw=outw|(code>>(len−shift)); code=code<<(32−len+shift).

These operations leave code left-justified (outw is also left-justified) in case of overflow and require fewer operations. However, knowledge of bit-pointer “bp” and length of code “len” is still required.

To track the bit pointer position, the dedicated bit pointer maintenance (“MAINT”) instruction is used. The MAINT instruction allows users to track overflow for powers of 2 (to simplify the modulo calculation), which can be programmed in a control register. In at least some embodiments, the value needed is 32 (i.e., 2̂5). The MAINT instruction reduces the number of operations needed to track the bit pointer location as shown below.

### MAINT B_f:B_bp, B_len, B_f:B_bp

### The MAINT Instruction Performs the Operations

| | | | |
|---|---|---|---|
| ADD | B_bp, | B_len, | B_bp_ ; bp_ +=len ; |
| AND | B_bp_, | A_32, | A_f ;f=bp_&32 ; |
| ANDN | B_bp_, | B_32, | B_bp ;bp=bp_%32; |

These operations add the length of the codeword “len” to the existing bit-pointer “bp” and if the result exceeds 32, a flag is set for B_f. Otherwise, B_f is 0. Also the incremented bit pointer is kept at modulo 32. This requires one addition and two parallel ANDs on the modified value. These operations can be done in a single cycle since the addition adds two 5-bit values, checks for a carry in the 6^{th} bit, and removes the carry if it exists to keep the value mod 32.

The serial assembly code that uses these two instructions is shown below. In at least some embodiments, use of the INS and MAINT instructions, enables put-bit operations to be performed on two independent channels in parallel.

| LOOP: | | |
|---|---|---|
| LDDW | *B_code_len_ptr++, | B_len:B_code_s |
| MV | B_code_s, B_code | |
| INS | B_outw:B_code, B_bp, | B_outw:B_code |
| MAINT | B_f:B_bp, B_len, | Bf:B_bp |
| [B_f] STW | B_outw, *B_out_ptr++ | |
| [B_f] MV | B_code, B_outw | |
| LDDW | *A_code_len_ptr++, A_len:A_code_s | |
| MV | A_code_s, A_code | |
| INS | A_outw:A_code, A_bp, | A_outw:A_code |
| MAINT | A_f:A_bp, A_len, Af:A_bp | |
| [A_f] STW | A_outw, ′A_out_ptr++ | |
| [A_f] MV | A_code, A_outw | |

For the looping case, the performance improvement resulting from use of the INS and MAINT instructions for variable length code insertion is 2×. This is because the resulting piped loop kernel works on two channels in the same 2 cycles, thus effectively doubling the throughput compared to the C64x+ performance for multichannel applications. The corresponding piped loop kernel is shown below.

*========================PIPE LOOP KERNEL=====================*
LOOP:

| | | | | | |
|---|---|---|---|---|---|
| MAINT | .L1 | A_f:A_bp, | A-len, | A_f:A_bp | ;[7,1] |

| ∥ | INS | .S1 | A_outw:A_code, | A_bp, A_outw:A_code ;[7,1] | |
|---|---|---|---|---|---|
| ∥ | MAINT | .L2 | B_f:B_bp, B_len, | B_f:B_bp | ;[7,1] |
| ∥ | INS | .S2 | B_outw:B_code, B_bp, | B_outw:B_code | ;[7,1] |
| ∥ | LDDW | .D2T2 | *B_code_len_ptr++, | B_len:B_code_s | ;[1,4] |
| ∥ | LDDW | .D1T1 | *A_code_len_ptr++, | A_len:A_code_s | ;[1,4] |

| | | | | | |
|---|---|---|---|---|---|
| | [A_f]MV | .S1 | A_code, | A_outw | ;[ 8,1] |
| ∥ | [A_f]STW | .D1T1 | A_outw, | *A_out_ptr++ | ;[ 8,1] |
| ∥ | [B_f]MV | .L2 | B_code, | B_outw | ;[ 8,1] |
| ∥ | [B_f]STW | .D2T2 | B_outw, | *B_out_ptr++ | ;[ 8,1] |
| ∥ | MV | .L1 | A_code_s, | A_code | ;[ 6,2] |

| | | | | |
|---|---|---|---|---|
| ∥ | MV | .S2 | B_code_s, | B_code ;[ 6,2] |

As shown in the pipe loop kernel above, the AND and ANDN operations related to the MAINT instruction are performed by an .L work unit. Meanwhile, operations related to the INS instruction are performed by an .S work unit. Further, since “outw” and “code” need to be a register pair, and since “code” and “len” need to be loaded as a register pair, an extra set of moves are required to moved the loaded code into the register pair.

For the list scheduled case, when work is performed on two channels, the original C64x, C64x+ code take 7 cycles after the codeword and length have been loaded as shown below:

| | LDDW | .D2T1 | *B_code_len_ptr++, | | A_code:A _len ;[ 1,0] |
|---|---|---|---|---|---|
| ∥ | LDDW | . D1T2 | *A_code_ptr++, | | B_code:B_len ;[ 1,0] |
| | NOP 4 | | | | |
| ----------------------------- 7 cycles from here to finish ------------------------------ | | | | | |
| | SHRU | .S2X | A_code, | B_bp, | B_csh ;[ 6,0] |
| ∥ | ADD | .L1X | A_bp, | B_len, | A_bp_ ;[ 6,0] |
| | SUB | .D2X | B_32, | A_bp, | B_nbp ;[ 7,0] |
| | OR | .L1X | B_csh, | A_outw, | A_outw ;[ 8,0] |
| ∥ | AND | .D2X | A_bp_, | B_32, | B_f ;[ 8,0] |
| ∥ | SHL | .S2 | B_code, | B_nbp, | B_csl ;[ 8,0] |
| | ADD | .D2X | B_bp, | A_len, | B_bp_ ;[ 9,0] |
| ∥ | SUB | .D1X | A_32, | B_bp, | A_nbp ;[ 9,0] |
| | [B_f]STW | .D2T1 | A_outw, | *B_out_ptr++ | ;[10,0] |
| ∥ | [B_f]MV | .D1X | B_csl, | A_outw | ;[10,0] |
| ∥ | SHL | .S1 | A_code, | A_nbp, | A_csl ;[10,0] |
| | OR | .D2 | B_csh, | B_outw, | B_outw ;[11,0] |
| ∥ | AND | .D1X | B_bp_, | A_32, | A_f ; [11,0] |
| | SHRU | .S1X | B_code, | A_bp, | A_csh ;[12,0] |
| ∥ | ANDN | .L1 | A_bp_, | A_32, | A_bp ;[12,0] |

| | | | | |
|---|---|---|---|---|
| ∥ | [A_f]STW | .D1T2 B_outw, | *A_out_ptr++ | ;[12,0] |
| ∥ | [A_f]MV | .L2X A_csl, | B_outw | ;[12,0] |

| | | | | | |
|---|---|---|---|---|---|
| ∥ | ANDN | .S2 | B_bp_, | B_32, | B_bp ;[12,0] |

In contrast, with the INS and MAINT instructions, the two channels are completed in 3 cycles after the code and length are loaded, thereby saving 4 full cycles for some other operations to run. In addition, even during the busy compute cycles some additional non-M units (e.g., L and S work units) are free in 2 out of the 3 cycles allowing for more threads to be parallelized within the current computation. Thus, these instructions will allow performance (the reduction is cycles) to be improved beyond 7/3=2.33×. As a comparison, the 3 cycle performance of the list scheduled case (once code and length have loaded as shown below) is the same as the looping performance on the C64x. Further, the INS and MAINT instructions are advantageously possible within the existing op-code space of the C64x and C64x+ architectures.

| LOOP: | |
|---|---|
| | ;[ 2,0] |

| | | | | |
|---|---|---|---|---|
| | LDDW | .D1T1 | *A_code_len_ptr++, | A_len:A_code_s ;[ 3,0] |
| ∥ | LDDW | .D2T2 | *B_code_len_ptr++, | B_len:B_code_s ;[ 3,0] |
| | NOP | 4 | | |

| ------------------------------------ 3 cycles from here to complete ------------------------------ | | | | |
|---|---|---|---|---|
| | MV | .L1 | A_code_s, A_code ;[ 8,0] | |
| ∥ | MV | .S2 | B_code_s, B_code ;[ 8,0] | |
| | INS | .S1 | A_outw:A_code, | A_bp, A_outw:A_code ;[ 9,0] |
| ∥ | MAINT | .L1 | A_f:A_bp, A_len, | A_f:A_bp ;[9,0] |
| ∥ | INS | .S2 | B_outw: B_code , | B_bp, B_outw:B_code ;[ 9,0] |
| ∥ | MAINT | .L2 | B_f:B_bp, B_len, | B_f:Bbp ;[ 9,0] |

| | | | | | |
|---|---|---|---|---|---|
| | [ A_f]STW | .D1T1 | A_outw, | *A_out_ptr++ | ; [10,0] |
| ∥ | [ A_f]MV | .S1 | A_code, | A_outw | ;[10,0] |
| ∥ | [ B_f]STW | .D2T2 | B_outw, | *B_out_ptr++ | ;[10,0] |
| ∥ | [ B_f]MV | .S2 | B_code, | B_outw | ;[10,0] |

To summarize, the INS and MAINT instructions described herein reduce the total number of DSP cycles needed to perform variable length code insertion. In the example loop given above, two sets of INS and MAINT instructions are performed on two data paths over 3 cycles. The two sets of INS and MAINT instructions may correspond to encoding in accordance with two alternative Huffman tables. In other words, it may not be possible to know a priori which Huffman table will give the best compression, so the INS and MAINT instructions may be used to encode received data in parallel based on two candidate Huffman tables. Thereafter, the bit stream produced by each data path is analyzed and the bit stream with fewest bits is selected as it is compressed more efficiently. This technique for selecting a Huffman table may be implemented for encoding standards (e.g., JPEG) that allow a particular Huffman table to be specified. In accordance with at least some embodiments, selection between multiple possible Huffman tables is deferred and is based on the results of real-time encoding by a DSP with parallel data paths, rather than a sub-optimal static selection.

The reduction of cycles by use of the INS and MAINT instructions applies to the both the looping (e.g., software pipeline) scenario and to the scheduled list (non-looping) scenario. Further, the INS and MAINT instructions reduce the total number of work units needed during at least some of the DSP cycles dedicated to variable length code insertion (i.e., increased amounts of parallel operations for work not related to variable length code insertion can be performed). Although the INS and MAINT instructions have been described for (and are compatible with) the C64x and C64x+ architectures, other DSP architectures may similarly benefit from a dedicated insert instruction and a dedicated bit pointer maintenance instruction for performing variable length code insertion.

FIG. 3 illustrates a system 300 in accordance with an embodiment of the disclosure. As shown, the system 300 comprises a DSP 304 coupled to a data source 302 and a data sink 316. The DSP 304 is configured to receive workload data from the data source 302 and to modify the workload data. The modified workload data is output by the DSP 304 and is received by the data sink 316. As an example, the data source 302 may be a processor or a memory. Likewise, the data sink 316 may be a processor or a memory. Additionally, the data sinks may be network devices that receive compressed video such as TCP/IP. In accordance with at least some embodiments, the DSP 304 modifies the received workload data by performing variable length code insertion as described herein. The DSP 304 may correspond to a VLIW architecture DSP (e.g., the C64x or C64x+ architectures described herein) or another DSP architecture now known or later developed.

In at least some embodiments, the DSP 304 performs variable length code insertion on workload data received from the data source 302 using a dedicated insert instruction (e.g., the INS instruction) 306 and a dedicated bit pointer maintenance instruction (e.g., the MAINT instruction) 308. The dedicated insert instruction operates, for example, as a shift right merge byte operation to any bit location of a register. The dedicated bit pointer maintenance instruction operates to track a bit pointer location resulting from the dedicated insert instruction. The modified workload data (modified by variable length code insertion operations) is output from the DSP 304 to the data sink 316. In at least some embodiments, the workload data corresponds to video data and the variable length code insertion operations are for video encoding and/or video transrating.

During the variable length code insertion operations, the dedicated insert instruction may, for example, cause selective insertion of 1 to 32 bits into a 32-bit register. When the register is full, the contents of the register are output and a next codeword begins. In conjunction with the dedicated insert instruction, the dedicated bit pointer maintenance instruction causes a register bit location following (e.g., adjacent to) inserted bits associated with the dedicated insert instruction to be marked. If there are any overflow bits resulting from the dedicated insert instruction being performed, a codeword comprising the bits of the filled register is moved to a memory (e.g., data sink 316) and the overflow bits form a next codeword. In accordance with at least some embodiments, a DSP register stores a left-justified codeword and the dedicated insert instruction inserts a variable number of bits from left to right in the register. In such embodiments, overflow bits for a next codeword are also left-justified.

The dedicated insert instruction 306 and the dedicated bit pointer maintenance instruction 308 may be executed, for example, during a loop mode 310 or during a list schedule (non-loop) mode 312 of the DSP 304. During the loop mode 310, the dedicated insert instruction 306 may be performed multiple times for video encoding workload of the DSP. Such use of the dedicated insert instruction 306 reduces a total number of DSP cycles and/or a total number of work units dedicated to video encoding during the video encoding workload. As another example, during the loop mode 310, the dedicated insert instruction may be performed multiple times for a video transrating workload of the DSP to reduce a total number of DSP cycles and/or a total number of work units dedicated to video transrating during the video transrating workload.

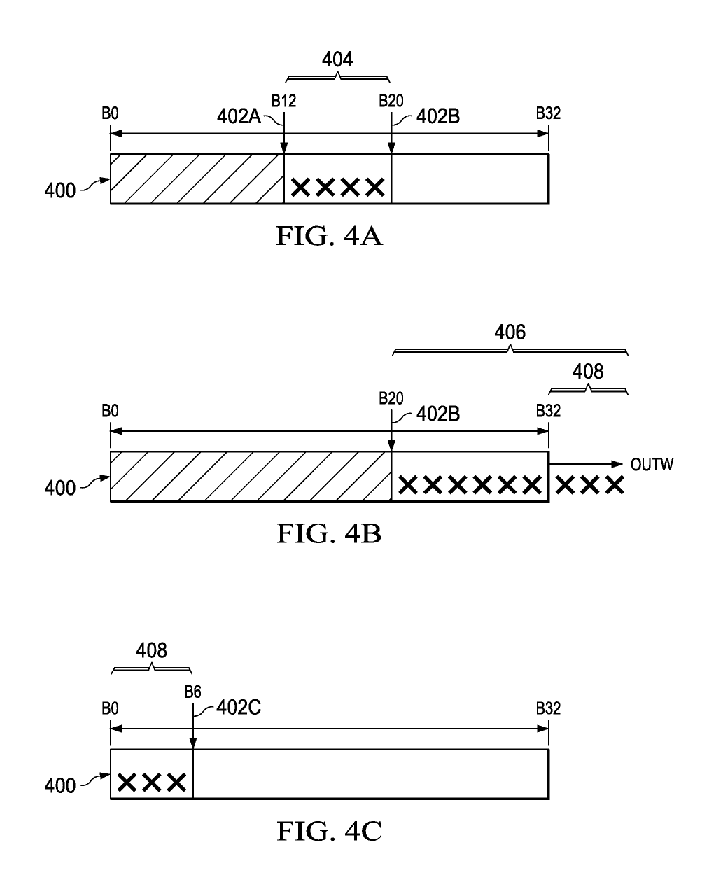

FIGS. 4A-4C illustrate a variable length code insertion process in accordance with an embodiment of the disclosure. In FIG. 4A, a 32-bit register 400 is already filled up to bit 12 of the register 400. The bit 12 location is marked as bit pointer position 402A. In response to a dedicated insert instruction, 8 inserted bits 404 are placed into register 400 from left to right, starting at bit 13. Along with the dedicated insert instruction being executed to place the 8 insert bits 404 into register 400, a dedicated bit pointer maintenance instruction is executed to update the bit pointer position to account for the inserted bits 404. With the additional of 8 inserted bits 404 in FIG. 4A, the dedicated bit pointer maintenance instruction causes bit 20 to be marked as the updated bit pointer position 402B.

In FIG. 4B, another dedicated insert instruction is executed to add 18 inserted bits to register 400. Accordingly, the final 12 bits of register 400 are filled with inserted bits 406 and 6 overflow bits 408 remain. In such case, the contents of filled register 400 are output as a codeword (outw) and the 6 overflow bits 408 begin a new codeword stored in the register 400 (e.g., after the previous codeword has been read out) as shown in FIG. 4C. In some embodiments, overflow bits may be stored in another register (i.e., two or more registers may be utilized for codeword storage). In either case, the dedicated bit pointer maintenance instruction causes register bit 6 to be marked as the updated bit pointer position 402C.

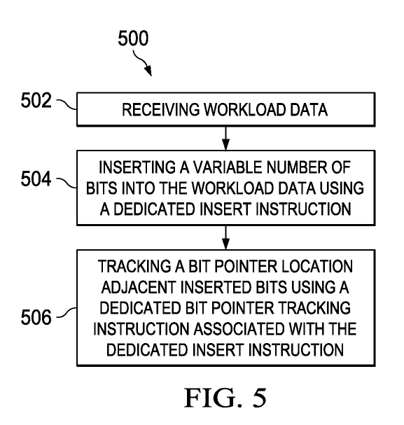

FIG. 5 illustrates a method in accordance with an embodiment of the disclosure. The method may be performed, for example, by a DSP as described herein. As shown in FIG. 5, the method 500 comprises receiving workload data (block 502). The workload data may comprise, for example, video data. At block 504, a variable number of bits are inserted into the workload data using a dedicated insert instruction. In at least some embodiments, left-justified workload data is loaded into a register and, in response to the dedicated insert instructions, bits are inserted from left to right into the register. The method 500 also comprises tracking a bit pointer location adjacent inserted bits using a dedicated bit pointer tracking instruction associated with the dedicated insert instruction (block 506).

In at least some embodiments, the method 500 may comprise additional steps. For example, the method 500 may additionally comprise performing variable length code insertion multiple times to encode video data using a loop mode (e.g., a software pipeline) of a DSP. Additionally or alternatively, the method 500 may comprise performing variable length code insertion multiple times for transrating video data using a loop mode (e.g., a software pipeline) of a DSP. The method 500 may additionally comprise detecting a filled register and sending a codeword comprising bits of the filled register to a memory. If there are any overflow bits resulting from executing a dedicated insert instruction, the method 500 may comprise starting a next codeword using the overflow bits.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A digital signal processor (DSP), comprising:
an instruction fetch unit;
an instruction decode unit in communication with the instruction fetch unit; and
a register set and a plurality of work units in communication with the instruction decode unit,
wherein the DSP selectively uses a dedicated insert instruction to insert a variable number of bits into a register.

2. The DSP of claim 1 wherein the register is a 32-bit register and wherein the dedicated insert instruction enables selective insertion of 1 to 32 bits into the register.

3. The DSP of claim 1 wherein the DSP uses a bit pointer instruction with the dedicated insert instruction, the bit pointer instruction causing a register bit location following inserted bits associated with the dedicated insert instruction to be marked.

4. The DSP of claim 1 wherein, if the register is filled and overflow bits remain due to the dedicated insert instruction being performed, a codeword comprising the bits of the filled register is moved to a memory and the overflow bits form a next codeword.

5. The DSP of claim 1 wherein the register set and the plurality of work units form two parallel data paths, and wherein two dedicated insert instructions are performed in parallel on the two parallel data paths.

6. The DSP of claim 1 wherein the dedicated insert instruction operates as a shift right merge byte operation to any bit location of the register.

7. The DSP of claim 1 wherein the register stores a left-justified codeword and the dedicated insert instruction inserts a variable number of bits from left to right in the register.

8. The DSP of claim 1 wherein the dedicated insert instruction is performed multiple times during a video encoding workload of the DSP to reduce a total number of DSP cycles or a total number of work units dedicated to video encoding during said video encoding workload.

9. The DSP of claim 1 wherein the dedicated insert instruction is performed multiple times during a video transrating workload of the DSP to reduce a total number of DSP cycles or a total number of work units dedicated to video transrating during said video transrating workload.

10. A system, comprising:
a data source that provides workload data;
a digital signal processor (DSP) coupled to the data source, wherein the DSP modifies the workload data from the data source using a dedicated insert instruction that inserts a variable number of bits into the workload data; and
a data sink that receives the modified workload data from the DSP.

11. The system of claim 10 wherein the DSP uses a pit pointer instruction with the dedicated insert instruction to mark a register bit location adjacent bits inserted by the dedicated insert instruction.

12. The system of claim 10 wherein the workload data comprises video data and wherein the DSP performs encoding or transrating of the video data by executing the dedicated insert instruction multiple times during a software pipeline.

13. The system of claim 10 wherein the DSP generates two different bit streams based on the workload data, the different bit streams being generated by performing the dedicated insert instruction on parallel data paths of the DSP and in accordance with different Huffman tables, and wherein one of the different bit streams is selected as the modified workload data.

14. The system of claim 10 wherein, when a register is filled due to the dedicated insert instruction being performed, a codeword comprising the bits of the filled register is moved to the data sink and any overflow bits are used to start a next codeword.

15. The system of claim 10 wherein the dedicated insert instruction operates as a shift right merge byte operation to any bit location of a register.

16. A method, comprising:
receiving, by a digital signal processor (DSP), workload data;
inserting, by the DSP, a variable number of bits into the workload data using a dedicated insert instruction; and
tracking, by the DSP, a bit pointer location adjacent inserted bits using a dedicated bit pointer tracking instruction associated with the dedicated insert instruction.

17. The method of claim 16 wherein the workload data comprises video data and wherein said inserting a variable number of bits into the workload data is performed multiple times to encode or transrate the video data during a software pipeline of the DSP.

18. The method of claim 16 further comprising generating two different bit streams based on the workload data, the different bit streams being generated by parallel data paths of the DSP and being based on different Huffman tables.

19. The method of claim 16 further loading left-justified workload data into a register and wherein said inserting a variable number of bits into the workload data comprising inserting bits into the register from left to right.

20. The method of claim 16 further comprising:
detecting a filled register and sending a codeword comprising bits of the filled register to a memory; and
if overflow bits result from said dedicated insert instruction, starting a next codeword.
